(19) United States
(12) Patent Application Publication
(10) Pub. No.: US 2017/0369717 A1
(43) Pub. Date: Dec. 28, 2017

(54) THICKENING AGENT FOR AQUEOUS SYSTEMS, FORMULATIONS CONTAINING SAME AND USES THEREOF

(71) Applicant: COATEX, Genay (FR)

(72) Inventor: Denis RUHLMANN, Genay (FR)

(73) Assignee: COATEX, Genay (FR)

(21) Appl. No.: 15/528,376

(22) PCT Filed: Dec. 18, 2015
(86) PCT No.: PCT/FR2015/053617

§ 371 Date: May 19, 2017

(30) Foreign Application Priority Data
Dec. 19, 2014 (FR) 1463021

(51) Int. Cl. C09D 7/00; C08L 75/04; C08L 5/16; C08G 18/75; C08G 18/48; C09D 5/02; C08G 18/28

(52) U.S. Cl. CPC C09D 7/002; C09D 5/024; C08L 75/04; C08G 18/283; C08G 18/755; C08G 18/4833; C08L 5/16

(57) ABSTRACT

The present invention relates to novel associative thickeners belonging to the category of the HEUR (Hydrophobically modified Ethoxylated URethanes), and also intermediate aqueous formulations containing such thickeners, and the final compositions, for example paint, lacquer, varnish or paper coating colour compositions.

The present invention relates to novel associative thickeners belonging to the category of the HEUR (Hydrophobically modified Ethoxylated URethanes) which make possible a good thickening/flow & levelling/sag resistance comprise, in particular to regulate a compromise between the flow & levelling and the sag resistance, of compositions containing it. These products contain an associative compound of polyethoxylated tristyrylphenol type. The present invention also relates to intermediate aqueous formulations containing such thickeners and to the use of these thickeners as flow and flow & levelling agents of the final compositions, for example paint compositions.

Paints consist of fillers and pigments and of at least one organic polymer known as binder. In addition to the fillers, the pigments and the binder, a paint formulation also comprises a solvent (which is water in the case of aqueous-phase paints), additives for the rheology, additives for the stability (storage, formation of the film, UV) and other additives for obtaining special properties. The behavior and the properties of the paints depend on the nature of their constituents, in particular of the binder, fillers and pigments and also rheological additives. They generally contain one or more thickeners, the role of which is to control the rheology of the formulations, both at the stage of their manufacture, as well as during their transportation, their storage or during their implementation. Given the diversity of the practical constraints at each of these steps, it is advantageous for the formulator to have available a range of thickeners having different rheological behaviors in formulation. In addition, these thickeners may contribute additional properties to the compositions, for example to the paints, which contain them.

The following are distinguished among all the thickeners for paints:
natural cellulose-based thickeners, also known as cellulose ethers, of HEC type or of HMHEC (Hydrophobically Modified HEC) type,
acrylic thickeners of non-associative type, known as ASE (Alkali Swellable Emulsions), and those of associative type, known as HASE (Hydrophobically modified Alkali Swellable Emulsions), and
associative thickening polyurethanes of HEUR (Hydrophobically modified Ethoxylated URethane) type.

The thickening polyurethanes or HEUR result from the condensation between a compound of poly(alkylene glycol) type, a polyisocyanate and an associative compound of alkyl, aryl or arylalkyl type consisting of a hydrophobic end group.

Coatex is the source of numerous research studies on paint thickeners. Furthermore, Coatex markets the products of the Coapur® range, for example the Coapur® XS products, which are nonionic thickening polyurethanes providing rheological profiles which vary between the newtonian type (high viscosity at high shear gradient and low viscosity at low shear gradient) and/or the pseudoplastic type (high viscosity at low shear gradient).

The document WO 02/102868 (Coatex), for example, relates to thickening polyurethanes of polymer type with an ethylene oxide chain, which comprise, at the chain ends, hydrophobic groups comprising several aromatic rings, in particular distyrylphenyl and tristyrylphenyl. Such thickeners make it possible to obtain a high viscosity at low shear gradient and a good pigmentary compatibility, whatever the type of paint (matt or satin).

The inventors have realized that, within this family of compounds, a certain number of structures make it possible to contribute, to the compositions which contain them, in particular to paints, an improvement in the compromise of the flow & levelling (self-levelling capability of the paint during the application, ASTM D4062 standard) and sag resistance (ASTM D4400 standard) properties while having the desired thickening.

Furthermore, the patent application EP 1 806 386 relates to the stability of the viscosity of a composition comprising a polymer in the form of a latex and a combination of thickeners.

The patent application WO 2009/154872 discloses the preparation and the use of compositions based on combinations of nonionic urethane thickeners.

This novel thickening polyurethane furthermore makes it possible to increase the viscosity at low and medium shear gradient (Brookfield™ and Stormer™ viscosities). It belongs to the category of the “balanced pseudoplastic” thickeners and thus provides a good compromise between the thickeners belonging to the category of the thickeners of pseudoplastic type and those belonging to the category of the thickeners of Newtonian type. It thus confers, to the composition which contains it, a good static behavior (significant thickening at low shear gradient) but also a good dynamic behavior (a satisfactory viscosity at medium and high shear gradients).

This novel thickener may furthermore be used in combination with a thickener of Newtonian type. Such a combination thus makes it possible to obtain a final composition having a better dynamic behavior related to the presence of the thickener of Newtonian type and a good static behavior related to the presence of the thickener according to the invention.

Such a thickener may be formulated in the aqueous phase and, by its specific structure, it makes possible a thickening of the final composition without requiring specific equipment or high shear energy.

### HEUR Thickener

An object of the present invention relates to a thickener belonging to the category of the HEUR (Hydrophobically modified Ethoxylated URethanes). It concerns the nonionic associative thickening polymer for aqueous compositions.

This thickening polymer makes it possible to thicken, at low and medium shear gradients, the formulations which contain them, in particular the paints, and also makes possible improved flow & levelling (self levelling capability of the paint during the application, ASTM D4062 standard) and sag resistance (ASTM D4400 standard) properties. The invention makes possible, surprisingly, a compromise between flow & levelling and sag resistance properties. By the specific choice of the polymers according to the invention, it is possible to prepare compositions having both satisfactory flow & levelling properties and satisfactory sag resistance properties, while having the desired thickening.

More specifically, it concerns a water-soluble thickening polyurethane resulting from the condensation:
a) of a mixture of compounds of formula (I):

R-(EO)ₘ—OH (I)
in which:
   R represents a radical comprising between 2 and 5 aromatic rings,
   (EO)ₘ represents a chain consisting of m ethoxylated units and
   m represents a mean value varying between 8 and 12 (limits included), provided that the R radical of at least one of the compounds of formula (I) represents a tristyrylphenyl group,
b) of at least one poly(alkylene glycol) and
c) of at least one polyisocyanate.

According to the present invention, the mixture of compounds of formula (I) comprises at least one compound of formula (I) of ethoxylated tristyrylphenol type.

Each compound of formula (I) comprises a polyethoxylated chain comprising at least 8 ethylene oxide (EO) units and at most 12 ethylene oxide units.

The present invention represents a selection of a polyurethane within the plurality of structures described in patent application WO 02/102868. This patent application describes nonionic thickeners having hydrocarbon groups at the chain ends comprising at least three substituted or unsubstituted aromatic rings. These chain ends may be poly(alkoxylated) and comprise between 2 and 80 ethylene oxide (EO) and propylene oxide (PO) units.

The novel polyurethanes comprise exclusively ethylene oxide units and the number of these units is limited to 8 to 12 units. These novel polyurethanes make it possible to thicken the formulations which contain them, in particular the paint formulations, at values of viscosity at medium shear gradient (Stormer™ viscosity) of less than 120 KU, but also to contribute to these formulations a flow & levelling value at least equal to 9, and also a sag resistance value at least equal to 14.

More specifically, it is these novel polyurethanes which make it possible to contribute, to the formulations which contain them, in particular to the paints, improved flow & levelling (self-levelling capability of the paint during application, ASTM D4062 standard) and sag resistance (ASTM D4400 standard) properties.

In particular, these polyurethanes may contribute a flow & levelling value at least equal to 9, and also a sag resistance value at least equal to 14.

According to one embodiment of the present invention, these polyurethanes contribute a flow & levelling value of greater than or equal to 9, for example of greater than or equal to 10, and also a sag resistance (or anti-sag) value of greater than or equal to 14, for example of greater than or equal to 15 or greater than or equal to 16.

These novel polyurethanes furthermore make it possible to thicken a paint formulation at low and medium shear gradients and also moderately at a high shear gradient, such a comparison test being carried out with aromatic structures of the prior art, for example as described in patent application WO 02/102868.

In particular, these polyurethanes may contribute a value of viscosity at medium shear gradient (Stormer™ viscosity) of less than 120 KU.

According to one embodiment of the present invention, these polyurethanes contribute a value of viscosity at medium shear gradient (Stormer™ viscosity) of less than or equal to 120 KU, for example of less than or equal to 110 KU.

According to another embodiment of the present invention, these polyurethanes contribute a value of viscosity at medium shear gradient (Stormer™ viscosity) of between 90 KU and 120 KU, for example between 95 KU and 110 KU.

The constituent a) of the polyurethane according to the invention consists of a mixture of compounds of the formula (I):

R-(EO)ₘ—OH (I)
in which:
   R represents a radical comprising between 2 and 5 aromatic rings,
   (EO)ₘ represents a chain consisting of m ethoxylated units and
   m represents a mean value varying between 8 and 12 (limits included).

Furthermore, at least one of the compounds of formula (I) comprises, as R radical, a tristyrylphenyl group. “Tristyrylphenyl” is understood to mean an aromatic phenol ring to which three styrene units are grafted.

Reference is made to a mixture of compounds of formula (I) because, in practice, the number of substitutions of the R radical is not exclusively 3, but commercial products comprise mixtures with a distribution centered on tristyrylphenyl.

On the other hand, each compound of formula (I) comprises the same mean number of ethoxylated units. The person skilled in the art thus understands that the mean value of m is identical in each compound of formula (I).

According to one embodiment of the present invention, the mixture of compounds of formula (I) comprises at least one tristyrylphenyl compound of formula (II):

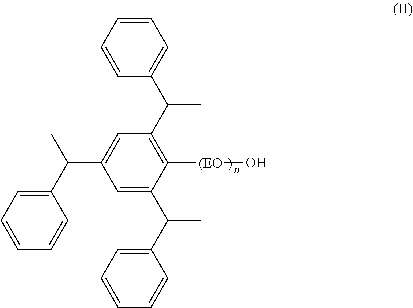

in which n represents an integer or decimal number varying between 8 and 12 (limits included).

According to another embodiment of the present invention, the mixture of compounds of formula (I) comprises, besides the tristyrylphenyl compound of formula (II), at least one compound of formula (III):

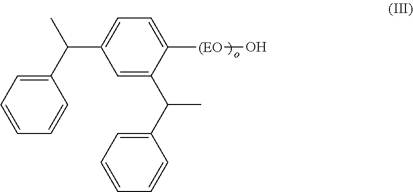

in which o represents an integer or decimal number varying between 8 and 12 (limits included).

According to another embodiment of the present invention, the mixture of compounds of formula (I) comprises, besides the tristyrylphenyl compound of formula (II), at least one compound of formula (IV):

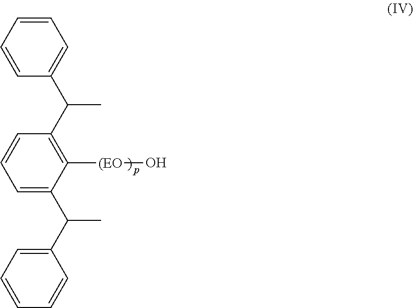

in which p represents an integer or decimal number varying between 8 and 12 (limits included).

According to another embodiment of the present invention, the mixture of compounds of formula (I) comprises, besides the tristyrylphenyl compound of formula (II), at least one compound of formula (V):

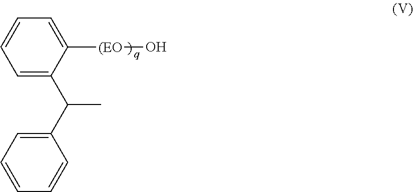

in which q represents an integer or a decimal number varying between 8 and 12 (limits included).

According to another embodiment of the present invention, the mixture of compounds of formula (I) comprises, besides the tristyrylphenyl compound of formula (II), at least one compound of formula (VI):

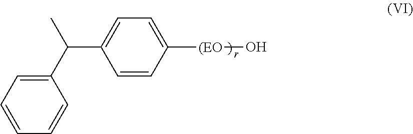

in which r represents an integer or decimal number varying between 8 and 12 (limits included).

According to another embodiment of the present invention, the mixture of compounds of formula (I) comprises, besides the tristyrylphenyl compound of formula (II), at least one compound of formula (VII):

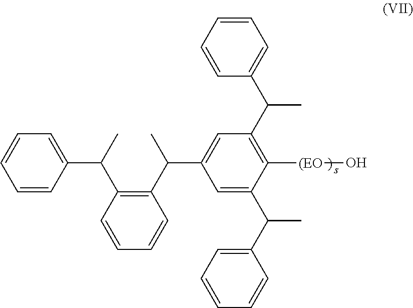

in which s represents an integer or decimal number varying between 8 and 12 (limits included),
as a mixture with a compound of formula (VIII):

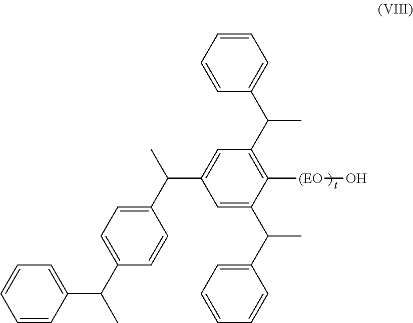

in which t represents an integer or decimal number varying between 8 and 12 (limits included).

According to another embodiment of the present invention, the mixture of compounds of formula (I) comprises, besides the tristyrylphenyl compound of formula (II), the compounds of formulae (III), (IV), (V), (VI), (VII) and (VIII). Thus, m in the formula (I) represents the mean of the values of the number of ethoxylations of each of the compounds of formulae (III), (IV), (V), (VI), (VII) and (VIII).

According to this embodiment, the proportions of the different compounds within the mixture are variable.

For example, it is possible to envisage the mixture of compounds of formula (I) to comprise a predominant proportion of tristyrylphenyl compounds of formula (II).

According to one aspect of the invention, the mixture of compounds of formula (I) comprises at least 40% by weight of the tristyrylphenyl compound of formula (II), for example at least 50% by weight or at least 60% by weight.

The mixture of compounds of formula (I) according to the invention is, for example, obtained by an alkylation reaction of phenol in the presence of styrene, followed by ethoxylation.

The operating conditions of such an alkylation reaction of a phenol in the presence of styrene are described in the prior art, for example in the document U.S. Pat. No. 2,432,356.

Furthermore, the polyurethane comprises, as constituent b), a poly(alkylene glycol).

“Poly(alkylene glycol)” is understood to mean a polymer of an alkylene glycol derived from an olefin oxide. The poly(alkylene glycol) chains of the constituent b) according to the present invention include a proportion of ethyleneoxy groups, a proportion of propyleneoxy groups and/or a proportion of butyleneoxy groups. The poly(alkylene glycol) chains according to the present invention may, for example, comprise a dominant proportion of ethyleneoxy groups in combination with a secondary proportion of propyleneoxy groups. Specific examples of alkylene glycol polymers comprise: poly(alkylene glycol)s with an average molecular weight of 1,000 g/mol, 4,000 g/mol, 6,000 g/mol and 10,000 g/mol; polyethylene-polypropylene glycols with a percentage of ethylene oxide of between 20% and 80% by weight and a percentage of propylene oxide of between 20% and 80% by weight.

According to one aspect of the present invention, the polyurethanes result from the condensation in particular of a poly(alkylene glycol) which is poly(ethylene glycol). It may, for example, be a poly(ethylene glycol), the molecular mass of which varies between 2,000 g/mol and 20,000 g/mol, for example between 8,000 g/mol and 15,000 g/mol (limits included). Mention may be made, by way of example, of poly(ethylene glycol) (or PEG) with a molecular mass varying between 10,000 g/mol and 12,000 g/mol (limits included).

Furthermore, the polyurethane comprises, as constituent c), a polyisocyanate. “Polyisocyanate” is understood to mean a compound which comprises at least two isocyanate —N═C═O functional groups.

According to one aspect of the present invention, the polyurethanes result from the condensation in particular of a polyisocyanate which is chosen from the group consisting of toluene diisocyanate, toluene diisocyanate dimers, toluene diisocyanate trimers, 1,4-butane diisocyanate, 1,6-hexane diisocyanate, isophorone diisocyanate, 1,3-cyclohexane diisocyanate, 1,4-cyclohexane diisocyanate, 4,4′-diisocyanatodicyclohexylmethane, 1-methyl-2,4-diisocyanatocyclohexane, diphenylmethylene diisocyanate (MDI), for example 2,2′-MDI, 2,4′-MDI, 4,4′-MDI or their mixtures, dibenzyl diisocyanate, a mixture of 1-methyl-2,4-diisocyanatocyclohexane and 1-methyl-2,6-diisocyanatocyclohexane, hexamethylene diisocyanate biuret, hexamethylene diisocyanate biuret dimers, hexamethylene diisocyanate biuret trimers and a mixture of at least two of these compounds.

According to one aspect of the invention, said polyurethane results from the condensation of:
a) from 1% to 29% by weight of at least one compound of formula (I),
b) from 70% to 98% by weight of at least one poly(alkylene glycol) and
c) from 1% to 29% by weight of at least one polyisocyanate,
   the sum of these mass percentages being equal to 100%.

According to another aspect of the invention, said polyurethane results from the condensation of:
a) from 3% to 10% by weight of at least one compound of formula (I),
b) from 80% to 94% by weight of at least one poly(alkylene glycol) and
c) from 3% to 10% by weight of at least one polyisocyanate,
   the sum of these mass percentages being equal to 100%.

The manufacture of the polyurethanes, which belong to the family of the thickeners of HEUR type, is known to the person skilled in the art, who may refer to the teaching of the documents cited above in the technological background of the present invention.

An object of the present invention also relates to a method for the preparation of a polyurethane as described above, said method consisting of a condensation of its different constituents.

According to another embodiment, the present invention relates to a thickener corresponding to the formula (IX):

R—O—(OE)ₓO-DI-(PEG-DI)ₙ—O—(OE)_{x′}O—R′ (IX)

according to which:
DI is a diisocyanate group, for example toluene diisocyanate, isophorone diisocyanate and/or hexamethylene diisocyanate,
PEG is a poly(ethylene glycol) group, for example with a molecular weight ranging from 6,000 g/mol to 20,000 g/mol,
n>1, for example between 2 and 5,
x and x′ varying between 8 and 12 and
R and R′ represent radicals comprising between 2 and 5 aromatic rings, as defined above.

### Formulation of the HEUR Thickener

The polyurethane according to the invention may be formulated or coformulated with other constituents or components.

Thus, the present invention also relates to an aqueous formulation comprising a polyurethane according to the invention, as described above.

This aqueous thickening formulation is intended to be incorporated in a final formulation, in the case in point known as “aqueous composition” or “final aqueous composition” for example a paint, a paper coating colour or a detergent composition.

The polyurethane according to the invention may be coformulated in the presence of water.

According to one embodiment, said aqueous formulation according to the invention consists of:
1) from 5% to 50% by weight of at least one polyurethane according to the invention, as described above, and
2) from 50% to 95% by weight of water,
   the sum of these mass percentages being equal to 100%.

According to another embodiment, said aqueous formulation according to the invention consists of:
1) from 5% to 25% by weight of at least one polyurethane according to the invention, as described above, and
2) from 75% to 95% by weight of water,
   the sum of these mass percentages being equal to 100%.

The polyurethane according to the invention may be coformulated in water, in the presence of at least one surface-active agent. Thus, the present invention relates, according to one embodiment, to an aqueous formulation comprising a polyurethane according to the invention, and also water and a surface-active agent. This surface-active agent makes it possible to formulate the thickener in the form of a less viscous aqueous liquid solution which may thus be more easily used by the formulator.

Thus, according to one embodiment of the present invention, said aqueous formulation comprises a polyurethane, as described above, and also water and at least one surface-active agent.

“Surfactant” or “surface-active agent” is understood to mean a molecule or a polymer consisting of at least a hydrophilic part and of at least a hydrophobic part.

The surface-active agent used in the context of the present invention may be different in nature, for example, it may be anionic or nonionic.

This surfactant may be selected from the categories of ionic surfactants (in this case, preferably anionic surfactants) and/or nonionic surfactants and/or mixed surfactants (comprising, in the same molecule, a nonionic and anionic structure). The preferred surfactant is composed of at least one surfactant selected from the category of nonionic surfactants, optionally in the presence of an anionic surfactant.

Mention may be made, among the suitable anionic surfactants, of sodium, lithium, potassium, ammonium or magnesium salts derived from alkyl ether sulfates with alkyl(s) varying from C₆ to C₁₂, in linear, iso, oxo, geminal, cyclic or aromatic configuration, or from C₁₂ alkyl sulfates, from alkyl phosphate esters or from dialkyl sulfosuccinates. The anionic surfactants are preferably used with at least one nonionic surfactant.

Mention may be made, as examples of mixed surfactants, of alkoxylated alkylphenol sulfonates. The nonionic surfactants may be used alone or in combination with an anionic surfactant. Mention may be made, as preferred examples of suitable nonionic surfactants, of: alcohols and ethoxylated (2 to 15 EO) C₄-C₁₈ fatty alcohols, ethoxylated (2 to 40 EO) C₄-C₁₈ Guerbet alcohols, ethoxylated (2 to 40 EO) C₄-C₁₈ iso and oxo alcohols, ethoxylated (2 to 40 EO) single-branched C₁₀-C₁₈ alcohols, C₁₈ sorbitol esters, ethoxylated (2 to 20 EO) sorbitol esters, ethoxylated (less than 15 EO) C₄-C₁₈ acids, ethoxylated (30 to 40 EO) castor oil, ethoxylated (7 to 60 EO) hydrogenated castor oil, esters such as glycerol palmitate, glycerol stearate, ethylene glycol stearate, diethylene glycol stearate, propylene glycol stearate, polyethylene glycol 200 stearate and ethoxylated (2 to 15 EO) C₁₈ esters. The hydrophobic chains may correspond to linear, iso, oxo, cyclic or aromatic structures.

According to one embodiment, the formulation comprises at least one nonionic surfactant optionally combined with at least one anionic surfactant, at a total content by weight ranging from 0.1% to 40% by weight, for example from 5% to 20% by weight or from 10% to 17% by weight. In this case, the ratio by weight between the two surface-active agents may, for example, vary between 25/75 and 75/25.

According to one embodiment of the present invention, the polyurethane of the present invention is formulated in the presence of more than two surface-active agents, for example three or four surface-active agents.

According to one embodiment, said aqueous formulation according to the invention consists of:
1) from 2% to 50% by weight of at least one polyurethane according to the invention, as described above, preferably from 5% to 30% by weight,
2) from 0.1% to 40% by weight of at least one surface-active agent, preferably from 5% to 30% by weight and
3) from 10% to 93% by weight of water, preferably from 40% to 85% by weight,
   the sum of these mass percentages being equal to 100%.

The polyurethane according to the invention may be formulated in a water-miscible solvent. The main reason for the addition of an organic cosolvent is to lower the viscosity of this polyurethane in water, in order to facilitate the handling. The polyurethane is, for example, formulated with one or more polar solvent(s) belonging in particular to the group consisting of water, methanol, ethanol, propanol, isopropanol, butanols, acetone, tetrahydrofuran or their mixtures.

Two specific examples of water-miscible organic solvents are:
diethylene glycol monobutyl ether (also known under the name of Butyl Carbitol™) or ethylene or propylene glycol ether and
butylene glycol ether.

The viscosity of the polyurethane as it is, before it is incorporated in a paint composition, for example, is preferably less than 10,000 mPa·s at 25° C. and at 100 revolutions per minute, so that it is easier to pour from the storage container and more rapidly incorporated in the composition to be thickened at room temperature. The water-miscible solvent chosen for such commercial compositions has, to date, exclusively been an organic solvent.

The polyurethane according to the invention may be coformulated in water, in the presence of a coalescent agent. Equivalently to a solvent, the coalescent agent makes it possible to formulate the thickener in the form of a less viscous aqueous liquid solution which may thus be more easily used by the formulator.

According to one embodiment, said aqueous formulation according to the invention consists of:
1) from 5% to 50% by weight of at least one polyurethane according to the invention, as described above,
2) from 5% to 30% by weight of at least one solvent and/or coalescent agent and
3) from 20% to 75% by weight of water,
   the sum of these mass percentages being equal to 100%.

According to one aspect of the invention, the aqueous formulation additionally comprises at least one additive selected from the group consisting of a biocide, a solvent, an anti-foaming agent, a pH regulator, a coalescent agent, an encapsulating agent and their mixtures.

“Biocide” is understood to mean a chemical substance intended to destroy, repel or render inoffensive harmful organisms, to prevent the action thereof or to combat them in any other way, by chemical or biological action.

“Anti-foaming agent” is understood to mean a substance or a formulation intended to destroy air bubbles within a homogeneous or heterogeneous liquid medium (or at its surface) or to prevent their formation.

“pH regulator” or “pH-regulating agent” is understood to mean a chemical compound which makes it possible to adjust the pH to the expected value. For example, the pH-regulating agent may increase the pH, this is the case with bases, such as NaOH. Alternatively, the pH-regulating agent may decrease the pH, this is the case with acids.

“Coalescent agent” is understood to mean an agent used in paints which makes it possible to lower the paint Minimum Film Formation Temperature (MFFT) to a temperature suited to the application conditions desired (for example a MFFT of 5° C. for an external application). Mention may be made, as examples of coalescent agents according to the invention, of propylene glycol, butyl glycol, dibutyl glycol, 2,2,4-trimethyl-1,3-pentanediol monoisobutyrate or 2,2,4-trimethyl-1,3-pentanediol diisobutyrate or glycol ether derivatives of Dowanol® type.

“Encapsulating agent” is understood to mean an agent which creates a hydrophobic environment, for example a solvation cage. Mention in particular is made, as encapsulating agent, of cyclodextrin.

According to one embodiment, said aqueous formulation according to the invention consists of:
1) from 2% to 50% by weight of at least one polyurethane according to the invention, as described above, preferably from 2% to 30% by weight,
2) from 0.1% to 40% by weight of at least one surface-active agent, preferably from 5% to 30% by weight,
3) from 10% to 93% by weight of water, preferably from 40% to 85% by weight and
4) from 0 to 5% by weight of at least one other additive chosen from the group consisting of a biocide, a solvent, an anti-foaming agent, a pH regulator, a coalescent agent, an encapsulating agent and their mixtures, preferably from 0.5% to 4% by weight,
   the sum of these mass percentages being equal to 100%.

### Thickening Agent—Flow & Levelling Agent—Anti-Sag Agent

The present invention also relates to the use of a polyurethane according to the invention or of an aqueous formulation according to the invention for thickening an aqueous composition, said composition being selected from the group consisting of a paint, a putty, a render coating, a thick coating, a waterproof coating, a lacquer, a varnish, an ink, a slurry, a paper coating colour, a cosmetic composition and a detergent composition.

The final aqueous composition conventionally comprises from 0.02% to 5% by weight of active ingredient of said thickener, for example from 0.05% to 2% by weight of active ingredient of said thickener. “Weight of active ingredient” is understood to mean the dry weight of polyurethane according to the invention, independently of the coformulation ingredients.

This final aqueous composition may comprise at least one mineral filler selected from the group consisting of calcium carbonate, kaolin, talc and silicate and/or at least one pigment selected from the group consisting of titanium dioxide, iron oxide and zinc.

The final aqueous composition may be a paint and comprise at least one dispersing agent, at least one mineral filler or pigment, at least one binder, at least one biocide, at least one anti-foaming agent and optionally a surface-active agent, a surface agent and/or a coalescent agent, a solvent.

According to one embodiment, the polyurethane according to the invention or thickening agent according to the invention or the aqueous formulation incorporating this polyurethane according to the invention may be used as anti-sag agent (according to the ASTM D4400 standard) and flow & levelling agent (according to the ASTM D4062 standard) of a final aqueous composition, for example of a paint.

Thus, the present invention also relates to a thickening, flow & levelling and anti-sag agent of final aqueous compositions consisting of a polyurethane responding to the technical characteristics described above.

In particular, this agent according to the invention makes it possible to contribute a flow & levelling value (measured according to the ASTM D4062 standard) of greater than or equal to 9 and also a sag resistance value (measured according to ASTM D4400 standard) of greater than or equal to 14.

Yet another object of the present invention relates to a polyurethane or an aqueous formulation according to the present invention which makes it possible to thicken an aqueous composition, for example selected from the group consisting of a paint, a putty, a render coating, a thick coating, a waterproof coating, a lacquer, a varnish, an ink, a slurry, a paper coating colour, a cosmetic composition and a detergent composition, to a viscosity value at medium shear gradient (Stormer™ viscosity) of less than 120 KU, for example less than or equal to 120 KU, for example less than or equal to 110 KU or, for example between 90 KU and 120 KU or between 95 KU and 110 KU.

This polyurethane furthermore makes it possible to confer to the formulations which contain them, in particular to the paints, a flow & levelling (self-levelling capability of the paint during application, measured on a Leneta contrast card, ASTM D4062 standard) value of greater than or equal to 9, for example of greater than or equal to 10, and also a sag resistance (or anti-sag, measured on a Leneta contrast card, ASTM D4400 standard) value of greater than or equal to 14, for example of greater than or equal to 15 or greater than or equal to 16.

The examples which follow make it possible to achieve a better understanding of the present invention, without limiting the scope thereof.

### EXAMPLES

The viscosity of the test formulations or of the paint compositions is determined at different shear rate gradients:
at low shear rate gradient: the Brookfield™ viscosity, which is measured using a Brookfield™ viscometer of RVT type, in the unstirred flask, at a temperature of 25° C. and at two rotational speeds of 10 and 100 revolutions per minute with the appropriate spindle. Reading is carried out after one minute of rotation. Two Brookfield™ viscosity measurements are thus obtained, which are respectively denoted μBk10 and μBk100 (mPa·s),
at medium shear rate gradient: the Stormer™ viscosity, denoted μS (Krebs Units) and
at high shear rate gradient: the Cone Plan viscosity or ICI viscosity, denoted μl (mPa·s).

Furthermore, the following are measured on a Leneta contrast card (room temperature):
the flow & levelling according to the ASTM D4062 standard and
the sag resistance or anti-sag according to the ASTM D4400 standard.

### Example 1

This example illustrates the thickening power of the polyurethanes in simple formulations containing a binder, water and said polyurethanes, making it possible to obtain a good level of discrimination between the different tests.

It illustrates the thickening power of the two polyurethanes according to the invention (tests 1-1 and 1-2), using a compound of formula (I) in which m has a value respectively of 8 and 10 and R is tristyrylphenyl.

### Test 1-1 (According to the Invention)

The polyurethanes described result from the condensation of, expressed as a percentage by weight based on the total weight of the polyurethane:
81.5% by weight of poly(ethylene glycol) with a weight-average molecular mass equal to 10,000 g/mol (PEG 10 000),
12.3% by weight of said mixture of compounds of formula (I) and
6.2% by weight of isophorone diisocyanate (IDPI).

### Test 1-2 (According to the Invention)

The polyurethanes described result from the condensation of, expressed as a percentage by weight based on the total weight of the polyurethane:
80.9% by weight of poly(ethylene glycol) with a weight-average molecular mass equal to 10,000 g/mol (PEG 10 000),
13.7% by weight of said mixture of compounds of formula (I) and
5.4% by weight of isophorone diisocyanate (IDPI)

All these polyurethanes are formulated in water in the presence of a surfactant which is a C₈-C₁₀ fraction of an alkoxylated fatty alcohol (Simulsol® OX1008). The PU/surfactant/water mass ratios are shown in Table 1 below.

### Test of the Thickening Power

In each of the tests 1-1 and 1-2, 140 g of Mowilith™ LDM 1871, 120 g of bi-permuted water and 32.8 g of the composition to be tested are introduced into a beaker. The Brookfield™ viscosities at 10 and 100 revolutions per minute (μ_{Bk10} and μ_{Bk100}, in mPa·s), the Stormer™ viscosity (μ_{S}, in Krebs Units KU) measured with the standard module and the ICI viscosity (μ_{I}, in mPa·s) of the formulation are then measured at 25° C.

The results appear in Table 1.

TABLE 1

| | Test No. | |
|---|---|---|
| | 1-1 | 1-2 |
| Thickener in the form of an aqueous | | |
| composition: | | |
| PU/surfactant/water ratio | 17.5/11.5/71 | 17.5/15/67.5 |
| Test formulation: | | |
| water | Water: 120 g | |
| binder: Mowilith ™ LDM 1871 | Binder: 140 g | |
| thickener | Thickener: 32.8 g | |
| According to the invention | INV | INV |
| μ_{Bk10} | 880 | 750 |
| μ_{Bk100} | 864 | 714 |
| μ_{S} | 80 | 75 |
| μ_{I} | 200 | 190 |

The polyurethanes according to the invention indeed have a thickening power and develop the desired thickening at a low shear rate gradient.

### Example 2

This example illustrates the use of a thickener according to the invention in a paint formulation, the composition of which is given in Table 2 below.

TABLE 2

| | Test No. | | | | |
|---|---|---|---|---|---|
| | 2-1 | 2-2 | 2-3 | 2-4 | 2-5 |
| Preletdown | | | | | |
| Water | 67 | 67 | 67 | 67 | 67 |
| Binder 2 | 274 | 274 | 274 | 274 | 274 |
| Binder 1 | 154 | 154 | 154 | 154 | 154 |
| Anti-foaming agent | 1 | 1 | 1 | 1 | 1 |
| TiO₂ (75 wt. % Kronos ™ 4310) | 343 | 343 | 343 | 343 | 343 |
| Stirring for 10-20 minutes | | | | | |
| Pigment mixture | | | | | |
| Water | 28 | 28 | 28 | 28 | 28 |
| Amine buffer | 1 | 1 | 1 | 1 | 1 |
| Solvent | 4.5 | 4.5 | 4.5 | 4.5 | 4.5 |
| Anti-foaming agent | 1 | 1 | 1 | 1 | 1 |
| Dispersant | 1.2 | 1.2 | 1.2 | 1.2 | 1.2 |
| Pigment extender | 20 | 20 | 20 | 20 | 20 |
| Preservative | 1.6 | 1.6 | 1.6 | 1.6 | 1.6 |
| High speed mixing for 20 min | | | | | |
| Addition of the preletdown to | | | | | |
| the pigment mixture | | | | | |
| Coalescent agent | 6.5 | 6.5 | 6.5 | 6.5 | 6.5 |
| Surfactant | 2 | 2 | 2 | 2 | 2 |
| Fungicide | 2.5 | 2.5 | 2.5 | 2.5 | 2.5 |
| Mixing for 2 minutes | | | | | |
| Addition to the preletdown | | | | | |
| Water | 18.5 | 18.5 | 18.5 | 18.5 | 18.5 |
| Open time additive | 10 | 10 | 10 | 10 | 10 |
| HEUR thickener effective at “high shear” | 40 | 40 | 40 | 40 | 40 |
| Acrysol RM825 | 3.4 | | | | |
| HEUR thickener effective at “low shear” | 0.5 | | | | |
| Thickening agent to be tested | | 5.0 | 4.0 | 4.0 | 5.0 |
| Plastic pigment | 30 | 30 | 30 | 30 | 30 |
| Wetting agent | 1 | 1 | 1 | 1 | 1 |
| Anti-foaming agent | 1.5 | 1.5 | 1.5 | 1.5 | 1.5 |
| Water | 54 | 54 | 54 | 54 | 54 |
| TOTAL (in parts) | 1066 | 1067 | 1066 | 1066 | 1067 |

This example illustrates the viscosity at medium shear gradient (Stormer™ in KU), the flow & levelling and the sag resistance of said paint formulation using a polyurethane according to the invention (tests 2-3 and 2-4), using a compound of formula (I) comprising 8 or 10 ethylene oxide units.

At the same time, this example also illustrates a polyurethane of Acrysol RM825 type (test 2-1, reference commercial product in the field of paints) and two polyurethanes according to the patent application WO 02/102868 (tests 2-2 and 2-5), using a compound respectively comprising 3 and 25 ethylene oxide units.

For each of the tests, the viscosity μ_{S} (in Krebs Units KU, measured with the standard module), the flow & levelling according to the ASTM D4062 standard and the sag resistance or anti-sag according to the ASTM D4400 standard were determined, according to the methods described above.

TABLE 3

| | Evaluation | | | | |
|---|---|---|---|---|---|
| | 2-1 | 2-2 | 2-3 | 2-4 | 2-5 |
| | OI | OI | INV | INV | OI |
| μₛ (in | 113 | 124.3 | 109.4 | 108.8 | 107 |
| Krebs Units KU) | | | | | |
| Flow & levelling | 9 | 6 | 10 | 9 | 10 |
| Sag resistance | 8 | 20 | 22 | 16 | 10 |

OI: Outside the Invention -
INV: according to the invention

### Test 2-1 (Outside the Invention—Acrysol RM825)

Neither the value of the flow & levelling, nor that of the sag resistance of the paint composition comprising Acrysol RM825 are sufficient to achieve a good thickening/flow & levelling/sag resistance compromise.

### Test 2-2 (Outside the Invention—3 Ethylene Oxide Units)

Although the value of the sag resistance is greater than 14, the thickening agent according to the test 2-2 does not make it possible to obtain a good compromise between viscosity at medium shear gradient (Stormer™ viscosity), on the one hand, and a flow & levelling value of greater than or equal to 9, on the other hand.

### Test 2-5 (Outside the Invention—25 Ethylene Oxide Units)

Neither the value of the flow & levelling, nor that of the sag resistance of the paint composition comprising the thickening agent according to the test 2-5 are sufficient to achieve a good thickening/flow & levelling/sag resistance compromise.

### Tests 2-3 and 2-4 (According to the Invention—Respectively 8 and 10 Ethylene Oxide Units)

Make it possible to obtain a formulation having a good thickening/flow & levelling/sag resistance compromise.

1: A water-soluble thickening polyurethane obtained by condensation:
a) of a mixture of compounds of formula (I):
R-(EO)ₘ—OH (I),
wherein:
R represents a radical comprising between 2 and 5 aromatic rings,
(EO)ₘ represents a chain consisting of m ethoxylated units and
m represents a mean value of 8 to 12,
wherein the radical R of at least one of the compounds of formula (I) represents a tristyrylphenyl group;
b) of at least one poly(alkylene glycol); and
c) of at least one polyisocyanate.

2: The water-soluble thickening polyurethane of claim 1, wherein the mixture of compounds of formula (I) comprises a tristyrylphenyl compound of formula (II): 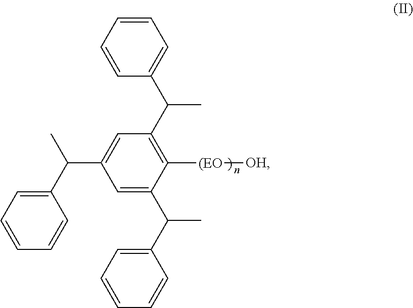
wherein n represents an integer or decimal number of 8 to 12.

3: The water-soluble thickening polyurethane of claim 1, obtained by the condensation of:
a) from 1% to 29% by weight of the at least one compound of formula (I),
b) from 70% to 98% by weight of the at least one poly(alkylene glycol), and
c) from 1% to 29% by weight of the at least one polyisocyanate,
wherein a sum of mass percentages of a), b) and c) is equal to 100%.

4: The water-soluble thickening polyurethane of claim 1, wherein the at least one poly(alkylene glycol) is a poly(ethylene glycol) having a molecular mass of between 2,000 g/mol and 20,000 g/mol.

5: An aqueous formulation, comprising:
the water-soluble thickening polyurethane of claim 1, and
water.

6: The aqueous formulation of claim 5, further comprising a surface-active agent.

7: The aqueous formulation of claim 5, further comprising at least one additive selected from the group consisting of a biocide, a solvent, an anti-foaming agent, a pH regulator, a coalescent agent, and an encapsulating agent.

8: The aqueous formulation of claim 5, consisting of:
1) from 2% to 50% by weight of at least one water-soluble thickening polyurethane,
2) from 0.1% to 40% by weight of at least one surface-active agent,
3) from 10% to 93% by weight of water and
4) from 0 to 5% by weight of at least one additive selected from the group consisting of a biocide, a solvent, an anti-foaming agent, a pH regulator, a coalescent agent, and an encapsulating agent,
wherein a sum of mass percentages of a), b) and c) is equal to 100%.

9: A method for thickening an aqueous composition, comprising contacting the aqueous composition with the water-soluble thickening polyurethane of claim 1,
wherein the aqueous composition is selected from the group consisting of a paint, a putty, a render coating, a thick coating, a waterproof coating, a lacquer, a varnish, an ink, a slurry, a paper coating colour, a cosmetic composition and a detergent composition.

10: An aqueous composition, comprising:
the water-soluble thickening polyurethane of claim 1 as an anti-sag agent, a flow & levelling agent, or both,
wherein the aqueous composition is selected from the group consisting of a paint, a putty, a render coating, a thick coating, a waterproof coating, a lacquer, a varnish, an ink, a slurry, a paper coating colour, a cosmetic composition and a detergent composition.

11: A method for thickening an aqueous composition, comprising contacting the aqueous composition with the aqueous formulation of claim 5,
wherein the aqueous composition is selected from the group consisting of a paint, a putty, a render coating, a thick coating, a waterproof coating, a lacquer, a varnish, an ink, a slurry, a paper coating colour, a cosmetic composition and a detergent composition.
